(19) United States
(12) Patent Application Publication
(10) Pub. No.: US 2023/0164682 A1
(43) Pub. Date: May 25, 2023

(54) SELECTION OF A RADIO ACCESS TECHNOLOGY FOR COMMUNICATING DATA BETWEEN NETWORK DEVICES

(71) Applicant: GOOGLE LLC, Mountain View, CA (US)

(72) Inventors: Thomas Klingenbrunn, San Diego, CA (US); Hung Tsang, San Jose, CA (US); Aamir Akram, San Jose, CA (US)

(21) Appl. No.: 17/917,470

(22) PCT Filed: Apr. 6, 2021
(86) PCT No.: PCT/US21/25857

§ 371 Date: Oct. 6, 2022

Related U.S. Application Data
(60) Provisional application No. 63/007,328, filed on Apr. 8, 2020.

(51) Int. Cl. H04W 48/18

(52) U.S. Cl. CPC H04W 48/18

(57) ABSTRACT

A user equipment (UE) that supports a plurality of radio access technologies (RATs) can implement a method for communicating with a radio access network (RAN). The method includes detecting (402C), by processing hardware, that an application executing on an operating system (OS) invoked an application programming interface (API) that passes information to lower one or more layers of a protocol stack, for facilitating RAT selection. The method also includes receiving (404C), via the API at the lower one or more layers, a parameter related to data the application expects to communicate within a certain period of time with the RAN, including receiving the parameter before the lower one or more layers receives the data from the application or the RAN. The method further includes causing (406C) at least one RAT to be selected from the plurality of RATs based at least in part on the parameter, for communicating the data.

### FIELD OF THE DISCLOSURE

This disclosure relates generally to wireless communications and, more particularly, to strategies for selecting radio access technologies in wireless cellular communication networks.

### BACKGROUND

In wireless cellular communication networks, user devices (commonly referred to using the acronym “UE” for “user equipment”) communicate data with remote hosts via a radio access network (RAN). Communicating data can include transmitting data, receiving data, or both. A UE in some cases can support communication with a certain RAN over a single radio access technology (RAT), such as a fourth-generation (4G) or a fifth-generation (5G) RAT. And in other situations, a UE can support communication over multiple RATs, such as 4G and 5G in a non-standalone (NSA) configuration.

An application executing on an operating system (OS) of a UE typically exchanges data with remote hosts using a library of high-level functions of the OS. For example, an application can invoke a function for creating a socket (a communication endpoint), a function to bind or associate the socket with a local address, a function to connect the socket to a remote host, etc. To implement this functionality, the OS library implements a communication or protocol stack in which higher layers pass commands and data to lower layers, and the lower layers pass responses and data to the higher layers. Thus, configuration at the transport layer depends on the parameters received from the session layer, configuration at the session layer depends on the parameters received from the presentation layer, etc.

When the UE initiates transfer of downlink or uplink data, the RAN initially may allocate 4G radio resources to a UE and subsequently, when the volume of data reaches a certain level, switch over to 5G radio resources in either NSA or as 5G-only. However, some applications do not transfer steady streams of data and instead communicate short bursts of data followed by “quiet” periods of no data transfer. These short bursts can trigger the switch from 4G to 5G radio resources at the RAN, but the period of data transfer may complete before the RAN and the UE fully set up the 5G radio resources. As a result, the additional signaling required for configuring the 5G radio resources unnecessarily consumes network resources and increases power consumption at the UE. Another example of an inefficiency can occur when the application needs to receive a large file, but the RAN does not switch from 4G or 5G until after exhausting the limits of buffering at the UE or the RAN.

### SUMMARY

The techniques of this disclosure allow an application executing on the OS of a UE that supports multiple RATs to bypass at least one layer of the communication stack and facilitate RAT selection in view of one or more parameters related to the data the application expects to communicate. To this end, the OS of the UE can expose an application programming interface (API) which the application can invoke to specify the parameter (e.g., the amount of data the application expects to transfer, the expected duration of the transfer session, the latency of the RAN in responding to the UE, the interval between a first transfer and a subsequent, second transfer), and an entity operating at a lower layer of the communication stack (e.g., the network layer, the transport layer) can provide this parameter to the RAN for efficient RAT selection. Alternatively, the entity (e.g., a controller or an instance of a software controller) operating at the lower layer can locally determine which RAT (or multi-RAT configuration) is likely to be more efficient and request that the RAN activate the selected RAT(s).

One example embodiment of these techniques is a method for communicating data with a RAN in a UE that supports a plurality of RATs. The method is implemented by processing hardware and includes detecting that an application executing on an OS invoked an API for facilitating RAT selection. The method also includes receiving, via the API, a parameter related to data the application expects to communicate within a certain period of time with the RAN. The method further includes causing at least one RAT to be selected from the plurality of RATs based at least in part on the parameter, for communicating the data.

Another example embodiment of these techniques is a method for communicating data with a RAN in a UE that supports carrier aggregation (CA). The method may be implemented by processing hardware and includes detecting that an application executing on an OS invoked an API for facilitating CA selection. The method also includes receiving, via the API, a parameter related to data the application expects to communicate within a certain period of time with the RAN. Further, the method includes causing one of (i) carrier aggregation or (ii) single-carrier operation to be selected based at least in part on the parameter, for communicating the data.

Another example embodiment of these techniques is a UE with processing hardware and configured to implement the methods above.

A further example embodiment of these techniques is a non-transitory computer-readable medium storing thereon instructions that implement an API configured to perform the methods above.

An additional embodiment of these techniques is a method in a RAN of RAT selection for communicating with a UE that supports a plurality of RATs. The method is implemented by processing hardware and includes receiving from a UE a parameter specified by an application executing on an OS of the UE via an API call. The parameter is related to data the application expects to communicate with the RAN within a certain period of time. The method also includes selecting, based at least in part on the received parameter, at least one RAT from the plurality of RATs for communicating the data.

Another example embodiment of these techniques is a method in a RAN of carrier selection. The method is implemented by processing hardware and includes receiving, from a UE, a parameter specified by an application executing on an operating system (OS) of the UE via an API call, the parameter related to data the application expects to communicate with the RAN within a certain period of time. The method also includes selecting, based at least in part on the received parameter, one of (i) carrier aggregation or (ii) single-carrier operation for the UE, for communicating the data.

A further embodiment of these techniques is a RAN including at least one base station and configured to implemented the methods above.

### BRIEF DESCRIPTION OF THE DRAWINGS

FIG. 1A is a block diagram of an example system in which a radio access network (RAN) and a user equipment (UE) can implement the techniques of this disclosure for selecting a radio access technology (RAT) based on one or more application-provided parameters;

FIG. 1B depicts an example implementation of the RAN of FIG. 1A;

FIG. 2 is a block diagram of an example communication stack of the UE of FIG. 1A, with an API providing direct access to a lower layer;

FIG. 3A is a graph of data volume as a function of time for an example data transfer between a RAN and a UE that implement known techniques for transitioning between a less advanced RAT and a more advanced RAT;

FIG. 3B is a graph of data volume as a function of time for an example scenario in which the UE of FIG. 1A uses the API of this disclosure to facilitate selection of the less advanced RAT for data transfer;

FIG. 3C is a graph of data volume as a function of time for an example scenario in which the UE of FIG. 1A uses the API of this disclosure to facilitate selection of the more advanced RAT for data transfer;

FIG. 4A is a flow diagram of an example method for causing a RAN to select a RAT by transmitting to the RAN a parameter provided by an application via an API, which can be implemented in a UE of this disclosure.

FIG. 4B is a flow diagram of an example method for selecting a RAT in view of a parameter an application specifies via an API, which can be implemented in a UE of this disclosure;

FIG. 4C is a flow diagram of an example method for facilitating RAT selection, which can be implemented in a UE of this disclosure; and

FIG. 5 is a flow diagram of an example method for selecting a RAT based on a parameter specified by an application of a UE via an API call, which can be implemented in a RAN of this disclosure.

### DETAILED DESCRIPTION OF THE DRAWINGS

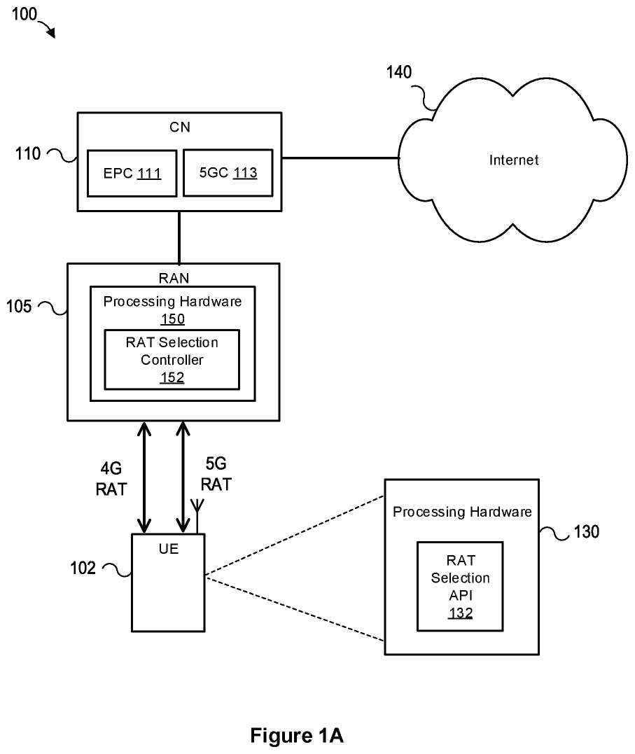

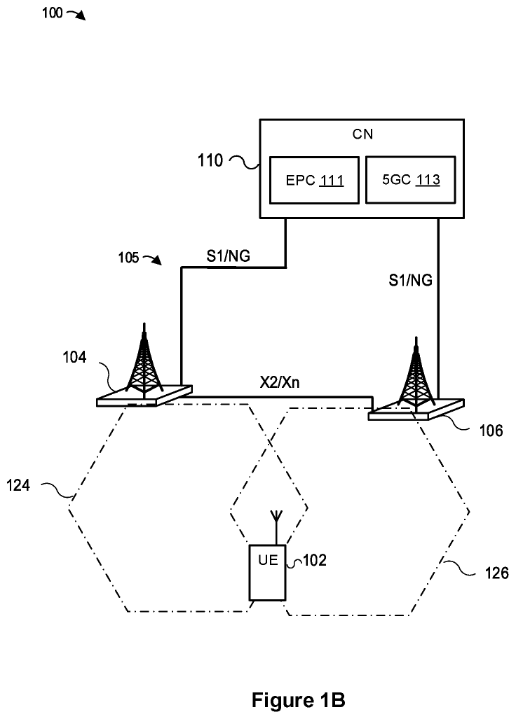

FIG. 1 illustrates an example communication system 100 in which a radio access network (RAN) and a user equipment (UE) can implement the techniques of this disclosure for selecting a radio access technology (RAT) based on one or more application-provided parameters. The communication system 100 includes a UE 102 and a RAN 105 that connects the UE 102 with a core network (CN) 110. The CN 110 communicatively connects the UE 102, via the RAN 105, to various communication networks including a wide area network or interconnected networks such as the Internet 140.

The UE 102 can be any suitable terminal device capable of wireless communication (e.g., any of the exemplary user devices discussed below, after the description of the figures). The UE 102 includes processing hardware 130, which may include one or more general-purpose processors (e.g., CPUs) and a computer-readable memory storing machine-readable instructions executable on the general-purpose processor(s), and/or special-purpose processing units. A memory of the UE 102 stores an operating system (OS), which can be any type of suitable mobile or general-purpose operating system. In addition, the memory can store one or more applications that communicate data with remote hosts via the RAN 105. Communicating data can include transmitting data, receiving data, or both.

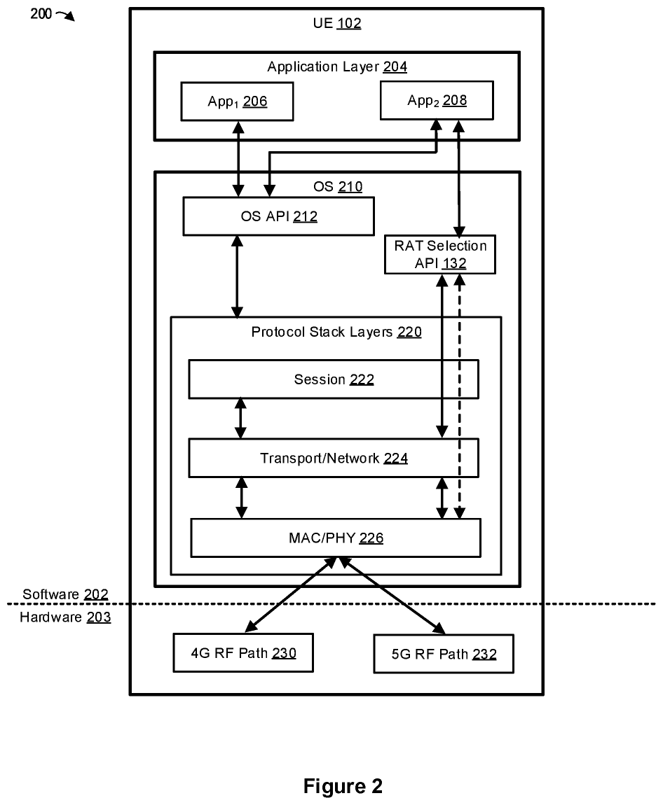

The processing hardware 130 further implements a RAT selection API 132, which provides to an application layer of the UE 102 direct access to a lower layer of the communication stack of the OS, discussed in more detail below with reference to FIG. 2. More specifically, the memory of the UE 102 may store instructions for implementing this API 132. Depending on the implementation, the RAT selection API 132 can be an OS API available to applications executing on the OS of the UE or an API of a service executing on the OS, for example.

The RAN 105 includes processing hardware 150 in or more base stations as discussed below with reference to FIG. 1B. The processing hardware 150 can include one or more general-purpose processors (e.g., CPUs) and a computer-readable memory storing machine-readable instructions executable on the general-purpose processor(s), and/or special-purpose processing units. The processing hardware 150 includes a RAT selection controller 152 configured to implement the techniques of this disclosure for selecting a RAT based on application-provided parameters. The RAT selection controller 152 may receive one or more parameters from the UE 102 and select a RAT, carrier aggregation (CA) scheme, multi-connectivity scheme, number of carriers, number of multiple-input, multiple-output (MIMO) layers, etc. based on the received parameter(s). The RAT selection controller 152 can select the RAT using the techniques discussed below with reference to FIGS. 2-5.

Although the examples in this disclosure refer primarily to selecting a single RAT from among multiple RATs, the techniques discussed below also can be used to select multiple RATs. For example, the RAT selection controller 152 may select two RATs in order to provide dual connectivity (DC) to the UE 102. Moreover, a controller operating at the radio resource control (RRC) or another suitable layer can select a certain carrier allocation scheme, such as single-carrier operation or carrier aggregation, based on the received parameters.

In some implementations, RAT Selection API 132, or another software component operating in the UE 102, duplicates (or replaces) some or all of the functionality of the RAT selection controller 152. For example, the API 132 can receive the one or more parameters from a software application, select a RAT, and select a cell that operates according to the selected RAT or request that the RAN 105 provide a radio connection with the UE 102 over the selected RAT. However, the API 132 in this implementation may not have the statistical data, channel occupancy data, signal quality measurement, etc. available to the RAT selection controller 152 operating in the RAN 152, and thus the UE API 132 in at least some of the cases may not select the RAT in the same manner as the RAT selection controller 152.

The CN 110 can be implemented as an evolved packet core (EPC) 111 or a fifth generation (5G) core (5GC) 160, for example. Among other components, the EPC 111 can include a Serving Gateway (S-GW) to transfer user-plane packets related to audio calls, video calls, Internet traffic, etc. and a Mobility Management Entity (MME) to manage authentication, registration, paging, and other related functions. The 5GC 113 can include a User Plane Function (UPF) 162 to transfer user-plane packets related to audio calls, video calls, Internet traffic, etc., an Access and Mobility Management (AMF) 164 to manage authentication, registration, paging, and other related functions, and/or Session Management Function (SMF) 166 to manage PDU sessions.

Further, the RAN 105 in some implementations can include a first base station connected to an EPC and a second base station connected to a 5GC, and the UE 102 can access a certain Internet host via the first base station and the EPC, or via the second base station and the 5GC.

FIG. 1B illustrates an example implementation of the RAN 105 of FIG. 1A. The RAN 105 includes base stations 104 and 106. Although shown as unitary base stations, base station 104 or 106 could be a distributed base station with a central node and one or more distributed nodes. While FIG. 1B depicts the RAN 105 as including two base stations, the RAN 105 can include any suitable number of base stations that collectively support two or more RATs. The base stations 104 and 106 provide coverage to cells 124 and 126, respectively. Each of the base stations 104 and 106 also may cover one or more additional cells not shown in FIG. 1B. The UE 102 can communicatively connect with the RAN 105 via the base station 104 when operating within the cell 124 or via the base station 106 when operating within the cell 126. The cells 124 and 126 at least partially overlap such that the UE 102 can be in range to communicate with more than one base station at a time.

In some implementations, each of the base stations 104 and 106 support a different RAT. For example, the base station 104 can be an eNB supporting a fourth-generation (4G) RAT, and the base station 106 can be a gNB supporting a fifth-generation (5G) RAT. In other implementations, one or both of the base stations 104 and 106 can support multiple RATs.

Each of the base stations 104 and 106 each support at least one interface, such as an Si interface or an NG interface, for communicating with the CN 110. In addition, to directly exchange messages with each other, the base stations 104 and 106 each support an X2 or Xn interface.

Next, FIG. 2 illustrates an example subsystem 200, including both software 202 and hardware 203, that implements a communication stack of the UE 102. Generally speaking, higher layers of the protocol stack pass commands and data to lower layers, and the lower layers conversely pass responses and data to the higher layers. The uppermost layer of the protocol stack is the application layer 204, at which applications such as an application 206 and an application 208 operate. These applications can include web browsers, mailing applications, messaging applications, video and audio players, gaming applications, etc. An operating system (OS) 210 facilitates interactions between the application layer 204 and the hardware 203 of the UE 102 which can include, among other components, chipset(s) and antenna(s) that define a 4G radio frequency (RF) path 230 as well as a 5G RF path 232. More generally, the UE 102 can include hardware to support any suitable number of RATs such as two or more RATs for cellular communications, one or more RATs to support a wireless local area network (WLAN) such as WiFi®, one or more RATs to support a wireless personal area network (WPAN) such as Bluetooth®, etc.

The OS 210 can implement protocol layers 220 of the protocol stack 200 to support communication with the RAN 105 over two or more RATs. In this disclosure, the term “protocol stack” refers to the full stack including the application layer 204 and the set of protocol layers 220, down to the hardware 203.

The protocol layers 220 can include for example (i) at least one higher layer 222, such as a session layer, (ii) at least one intermediate layer 224 such as a transport or a network layer, and (iii) at least one layer 226 such as a medium access control (MAC) layer and some of the functionality of the physical (PHY) layer (with the remaining functionality implemented in the hardware 203). Generally speaking, the session layer opens, coordinates, and closes communication sessions between applications at the application layer 204 and another communication endpoint accessible via the RAN 105; the transport layer coordinates data transfer, and the network layer coordinates packet forwarding, between applications and other communication endpoints; the MAC layer (which may be a sublevel of a data link layer above the PHY layer) coordinates transfer of data frames and manages flow control to prevent collisions; and the PHY layer manages the hardware 203 used to communicate with the RAN 105. In other implementations, the protocol layers 220 can include additional, fewer, or different layers not illustrated in FIG. 2.

When the application 206 or 208 has data to communicate with a remote host, the application interacts with the protocol layers 220 by invoking OS APIs, such as an OS API 212. The normal information flow between the application layer 204, OS layer 210, communication stack 220, and hardware 203 is illustrated on the left of FIG. 2 by the arrows starting at the application 206. To exchange (i.e., receive or transmit) data with a remote host, the application 206 invokes the OS API 212 to open a connection (e.g., to create a communication endpoint or socket) to a certain port on the remote host, for example. The OS API 212 passes the request to the uppermost of the protocol layers 220, which in this example implementation is the session layer 222. After receiving the connection request from the application 206 via the OS API 212, the session layer 222 initiates the process of establishing a connection. To this end, the session layer 222 identifies and passes the necessary information down the communication stack 220 to the intermediate layers 224, which then identify and pass the necessary information to the lower layers 226.

In contrast, information flow that involves the RAT selection API 132 is illustrated on the right of FIG. 2 by the arrows starting at the application 208. The application 208 also can invoke the OS API 212 to perform the standard functions such opening a communication session, sending a data packet or a data stream, receiving a data or a data stream, closing the communication session, etc. However, the application 208 additionally can invoke the RAT selection API 132 to pass parameters directly to the intermediate layers 224, such as the transport layer and/or the network layer. Thus, the RAT selection API 132 allows a software application to bypass at least one layer of the protocol layers 220 and of the communication stack 200, thereby providing applications with direct access to a layer of the communication stack 200 conventionally accessible only through at least one other layer.

From the intermediate layers 224, parameters provided via the RAT selection API 132 can flow to lower layers 226. The intermediate layers 224 and/or the lower layers 226 can configure the information for transport to the RAN 105, and the UE 102 can transmit a message to the RAN 105 including the parameters. The message may conform to a protocol for controlling radio resources between the UE 102 and the RAN 105, such as the existing radio resource control (RRC) protocol.

Using the RAT selection API 132, the application 208 can specify one or more parameters that RAN 105 and/or the UE 102 can utilize to determine which RAT is most suitable for efficiently communicating the data to which the parameter(s) pertain. More particularly, the one or more parameters relate to data that the application 208 expects to communicate with the RAN 105 within a certain period of time. The period of time can be an agreed-upon value (e.g., 10 sec, 1 minute, 5 minutes) which the UE 102 and the RAN 105 can store as a parameter, or the RAT selection API 132 can receive the time period as an additional parameter. Thus, an application in one instance can invoke the RAT selection API 132 and specify an expected file transfer of 5000 MB over a period of three minutes, and invoke the RAT selection API 132 in another instance to specify an expected streaming transfer of 100 MB over a period of ten minutes.

Examples of the parameters include: (i) an amount of data to be transferred (e.g., an amount in MBs, a number of packets, a size of packet(s) the application expects to transfer, payload length(s)), (ii) an expected duration of a transfer session (e.g., the application may indicate whether it expects a continuous session or a short burst of data), (iii) a latency (e.g., a latency of the RAN in responding to the UE, also referred to as a ping latency), (iv) an interval between a first transfer session and a second transfer session expected to occur subsequently to the first transfer session (e.g., an expected time after completing a transfer that a next transfer will start), (v) parameters related to a buffer (e.g., buffer size, amount of buffer expected to be filled, a buffer status), and (vi) power consumption estimates for communicating the data. The parameters may also include a time the application 208 expects the transfer to start or end, expressed either as a relative time or as an absolute time. Further, the parameters may indicate the priority of application traffic.

As a more specific example, a music listening application executing on the UE 102 can receive, via the user interface of the UE 102, a command to start continuous playback of a certain “station.” The application can invoke the RAT selection API 132 and specify that data transfer will last indefinitely (e.g., by setting the time parameter to “infinity” or some predefined maximum value), that the expected data rate is 1 MB per second, that the transfer should not proceed in bursts (e.g., by specifying HTTP chunks of a certain size such as 512 KB and/or TCP packet size, specifying the maximum latency, specifying differentiated services code point (DSCP) priority), specifying the desired buffer size, and providing other parameters generally separated from the uppermost of the protocol layers 220 by one or more protocol layers.

In another example, the music listening application receives a request to stream a single particular track from a remote host. The application can retrieve a tag or other metadata related to the track and determine the audio encoding scheme and/or the available streaming rates, the length of the track, etc. Because the application expects the data transfer to stop after playing back the single track, the application can provide different parameters to the RAT selection API 132 (e.g., setting the time parameter to approximately the duration of the track) as well as parameters similar to the continuous streaming scenario (e.g., the same buffering and priority parameters).

As yet another example, a web browser application can allow a user to select and download a music file or a document file from a website. In response to the user selecting an individual file or multiple files for download, the application can determine the overall amount of data the UE 102 will receive, the time limit for downloading the files (which can be application-specific or file-type-specific), etc. Unlike the music streaming scenarios discussed above, file download is generally tolerable to bursts of transmission as well as to certain delays, and the application can provide different parameters to the RAT selection API 132 in this scenario.

The UE 102 can pass some or all of these application-provided parameters to the RAN 105. The RAN 105 (e.g., the RAT selection controller 152) can use the application-provided parameters to select a RAT that is likely to be more efficient for communicating application data during an upcoming session. In addition to network efficiency, the RAN 105 can also consider power resources at the UE 102 in selecting a RAT. The RAN 105 can implement several techniques to select an appropriate RAT, as discussed below.

For example, after the application 208 specifies the amount of data the application 208 expects to communicate within a certain period of time as discussed above, the RAN 105 can estimate the amount of time transfer of this data is expected to take over a RAT that the UE 102 is currently using (e.g., attached to or connected to). The RAN 105 can also can estimate the amount of time transfer of at least a portion of the data (to account for data transfer during the transition between the RATs, as discussed below) or the entirety of the data is expected to take over a different RAT, which may support a higher data rate than the first RAT.

More particularly, the RAN 105 in one implementation determines that the UE 102 can switch to the other RAT immediately or almost immediately, so that the switch time is negligible, and the amount of data the UE 102 transfers over the first RAT prior to switching is relatively small or even zero. The RAN 105 in this case can estimate the amount of time required to transfer substantially all of the data over the second RAT or over both RATs, for comparison to the time required to transfer substantially all of the data over the first RAT.

In other implementations, however, the RAN 105 includes in the estimate for the second RAT the time required for the UE 102 to switch over the second RAT and, in some cases, how much of the data the UE 102 transmits over the first RAT prior to completing the switch. According to one such implementation, when the RAN 105 expects the data transfer to start via the first RAT and complete via the second RAT or both RATs, the RAN 105 estimates (i) an amount of time that transfer of a first portion of the data is expected to take over the first RAT before the transition completes, and (ii) an amount of time that transfer of the remaining data is expected to take over the second RAT or both RATs after the transition completes.

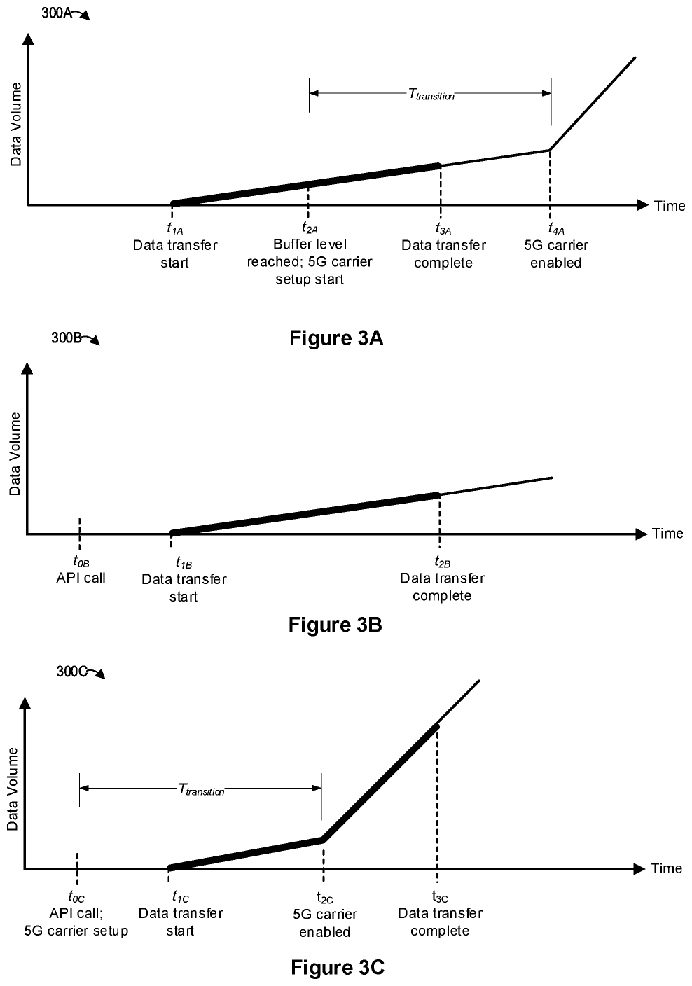

If the RAN 105 estimates that the time to complete a transfer over a first RAT is less than the time to transition to another RAT, then the RAN 105 can select only the first RAT for data transfer and choose not to turn on carriers for the other RAT, as in the scenario discussed below with reference to FIG. 3B. If the RAN 105 estimates that the time to complete a transfer over a first RAT is longer than the time to transition to another RAT and transmit a portion of the data over the second RAT or both RATs, then the RAN 105 can enable carriers of the other RAT to complete the data transfer, as in the scenario discussed below with reference to FIG. 3C.

The RAN 105 can estimate expected time periods based on expected data rates over different RATs. For example, the RAN 105 can utilize historical data from previous communications with the same or different UEs over different RATs to determine the expected data rates. The historical data may pertain to particular locations, and thus the expected data rates may be different for different locations of the UE 102. The UE 102 can provide location information to the RAN 105, or the RAN 105 can estimate a location of the UE 102 based on the location of the cell(s) serving the UE 102 and/or signal strength measurements reported by the UE 102. As a particular example, the RAN 105 can access aggregate resource information, which may be specific to particular locations, defined as the sum of bandwidth per carrier multiplied by the number of MIMO layers per carrier. The RAN 105 can access past bandwidth and MIMO information using past configuration messages between the RAN 105 and multiple UEs, for example. In addition to the application-specified parameters, the RAN 105 can assess the availability of network resources and radio link qualities over different RATs to estimate the data rates.

In addition to using the application-specified parameters to select a RAT, the RAN 105 may also use the parameters to manage other network resources. For example, the RAN 105 may select a number of 4G or 5G carriers, select a carrier aggregation scheme, or configure dual connectivity for the UE 102 based on the parameters. As another example, the RAN 105 may adjust a number of 4G or 5G MIMO layers.

Still further, the RAN 105 may determine whether to switch back to 4G-only radio resources after completing a transfer using 5G radio resources. For example, if the parameter indicates a short expected interval before a next transfer, and/or that the next transfer is for a large amount of data, then the RAN 105 may retain 5G carriers for the next transfer session. If the parameter indicates a long interval before a next transfer (e.g., an interval longer than the time required to transition back to 4G radio resources), the RAN 105 may proactively release the 5G carriers after a completed transfer. As another example, the application can indicate that it expects to receive X₁ bytes of data (or, alternatively, that it expects to receive for T₁ seconds), followed by a period of downlink inactivity of duration T₂, and further followed by receiving X₂ bytes of data (or actively receiving for T₃ seconds). The RAN 105 can receive or calculate the values for T₁ and T₃ to determine whether the relationship between T₁, T₂, and T₃ supports the decision to retain 5G carriers or switch back to 4G-only carriers. To this end, the RAN 105 can compare the interval T₂ to a certain threshold value, compare the ratio between T₂ and (T₁+T₃) to a certain threshold value, use a machine learning model to determine whether the UE 102 should retain the 5G connection, etc.

While this disclosure describes various techniques for selecting a RAT (and/or determining whether to release 5G carriers, selecting a number of carriers, a carrier aggregation scheme, a number of MIMO layers, etc.) primarily with reference to the RAN 105, the UE 102 also can implement at least some of these techniques. For example, based on statistics that the UE 102 collects or that the RAN 105 sends to the UE 102, the UE 102 can determine expected data transfer rates at the current location of the UE 102. Further, the UE 102 can use power consumption statistics to determine an expected amount of power that transfer over each RAT will require. For example, the UE 102 may select a 4G-only RAT if the amount of power required to transfer data over the 4G RAT is less than an amount of power required to transition to 5G carriers and complete some or all of the transfer over the 5G RAT. The UE 102 can also transmit power consumption information to the RAN 105. In some implementations, applications can also provide estimated power information related to an upcoming data transfer via the RAT selection API 132, allowing the RAN 105 to take power efficiency into consideration when selecting a RAT.

In some implementations, it is advantageous that the RAN 105 perform the selection and any accompanying analysis (such as comparison of time to complete a transfer using 4G-only versus 5G-only or a combination of 4G and 5G resources) to select the appropriate RAT because the RAN 105 has access to more information regarding network resources than the UE 102. However, depending on the implementation and/or scenario, the UE 102 may generate, or the RAN 105 may communicate, information that, in conjunction with the application-provided parameters, the UE 102 can use to perform the RAT selection and resource management functionality of this disclosure.

For further clarity, the graphs of FIGS. 3A-3C illustrate how the application-specified parameters can affect data volume transferred as a function of time.

FIG. 3A depicts a graph 300A of data volume (e.g., measured in MB) as a function of time for an example data transfer between the RAN 105 and the UE 102 implementing known techniques (i.e., without utilizing the RAT selection API) for transitioning between a 4G RAT and a 5G RAT. While FIGS. 3A-3C discuss transitioning between a 4G-only RAT and a 5G-only RAT, the discussions would also apply to transitioning between any first RAT and a second RAT with a higher peak data rate than the first RAT and may also apply to adding carriers or connectivity of a second RAT to augment the first RAT. In the scenario depicted in FIG. 3A, an application 206 executing on an OS 210 of the UE 102 may initiate a data transfer session with the RAN 105, for example by calling on a known OS API 212 to open a socket at the session layer 222. At time t_{1A}, after the 4G connection is set up, the UE 102 begins to exchange data with the RAN 102 using 4G carriers. At time t_{2A}, the volume of data reaches a threshold level that triggers set up of 5G carriers at the RAN 105 (e.g., the volume of data may reach a buffer level of the RAN 105 or the UE 102). At time t_{3A}, the data transfer completes while the UE 102 is still using 4G carriers to communicate the data. However, setup of 5G carriers does not complete until t_{4A} due to a non-zero transition time Tₜᵣₐₙₛᵢₜᵢₒₙ between when 5G carrier setup is triggered to when setup completes. Thus, no data is left to communicate over the 5G carriers during the session. In this scenario, the additional signaling required for configuring the 5G radio resources unnecessarily consumes network resources and increases power consumption at the UE. Such scenarios may occur if, for example, the application transmits short bursts of data which trigger the switch from 4G to 5G radio resources but complete more quickly than their initial data volume suggests.

FIG. 3B is a graph 300B of data volume as a function of time for an example scenario in which the UE 102 of FIG. 1A uses the RAT selection API 132 of this disclosure to facilitate selection of the 4G RAT for data transfer. At time t_{0B}, an application can invoke the RAT selection API 132 (e.g., via an API call) to specify a parameter related to data the application expects to communicate with the RAN 105 within a certain period of time. Based on the parameter, the RAN 105 can determine whether or not to setup 5G carriers to transfer a portion of or all of the data. The RAN 105 can make this determination using the techniques discussed above (e.g., by comparing an amount of time to transfer the data over the 4G RAT with an amount of time to transition to the 5G RAT or transfer at least a portion of the data over the 5G RAT). In the scenario of FIG. 3B, the RAN 105 selects only the 4G RAT to transmit the data irrespective of the buffer fullness. Thus, the RAN 105 does not expend network resources enabling 5G carriers, and the UE 102 does not utilize power configuring itself to communicate over 5G carriers. At the same time, or shortly after t_{0B}, the application may invoke other OS APIs for initializing the communication session and exchanging the data with the RAN 105. At time tis, the data transfer starts. At time t_{2B}, the data transfer completes using the 4G RAT.

In FIG. 3B, the RAN 105 utilizes the parameters an application specifies via the RAT selection API 132 to improve network efficiency by selecting a 4G RAT for the entire session. In other scenarios, however, the RAN 105 may select a 5G RAT for communicating all or a portion of the data in order to optimize efficiency.

For instance, FIG. 3C depicts a graph 300C of data volume as a function of time for an example scenario in which the UE 102 of FIG. 1A uses the RAT selection API 132 to facilitate selection of a 5G RAT for data transfer. At time toc, as at time t_{0B}, an application 208 invokes the RAT selection API 132 to specify a parameter related to data the application expects to communicate with the RAN within a certain period of time. In this scenario, the RAT 105 selects the 5G RAT to transmit the data based on the parameter. For example, the parameter may indicate that the application is expecting to transmit a large amount of data over a time longer than the period Tₜᵣₐₙₛᵢₜᵢₒₙ required to add 5G carriers or connectivity. Depending on the scenario, the application may exchange all or a portion of the data with the RAN via the 5G carriers. In FIG. 3C, the RAN 105 initializes 5G carrier setup at (or shortly after) time toc based on the parameter. During the transition period, data transfer can begin over the 4G radio resources and the application can start to exchange data with the RAN at time t_{1C}. When the transition completes at time t_{2C} and 5G carriers are enabled, the application can transmit at least some of the remaining portion of the data over the 5G radio resources until the data transfer completes at t_{1C}. Due to the higher data transfer rate over 5G radio resources (as indicated by the changed slope of the line in FIG. 3C starting at time t_{2C}), the data transfer can complete earlier than if the RAN 105 had not initiated 5G carriers, and earlier than if the RAN 105 had waited to initialize 5G carrier setup until a threshold volume of data was reached.

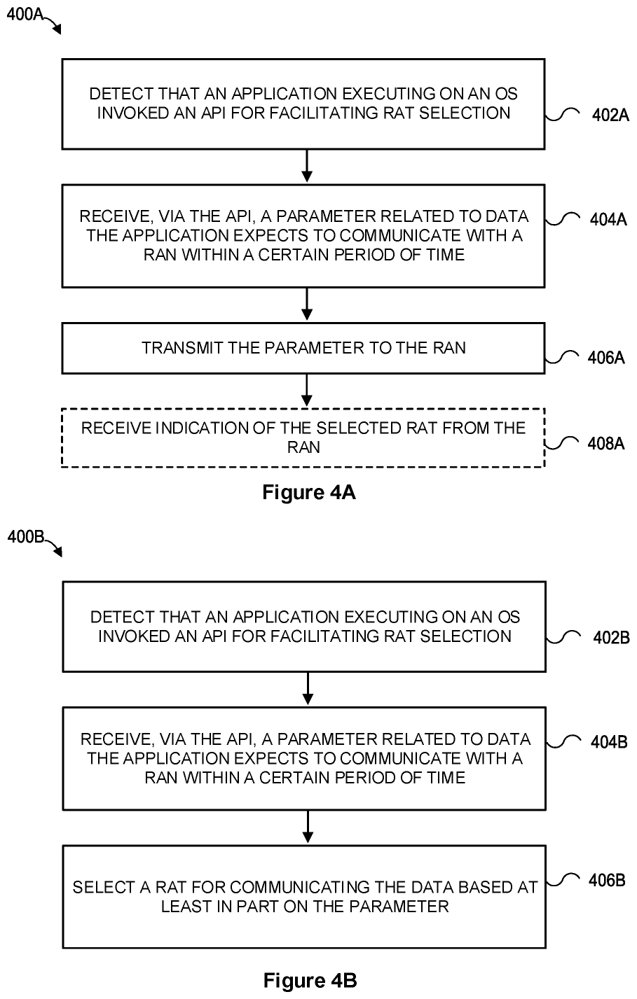

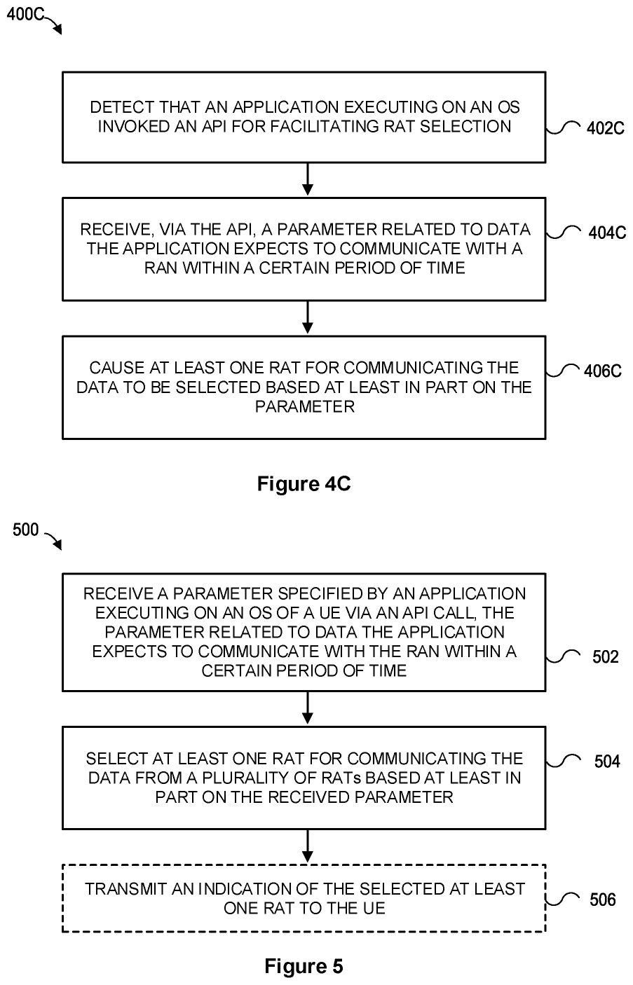

FIG. 4A is a flow diagram of an example method 400A for causing a RAN to select a RAT by transmitting to the RAN a parameter provided by an application via an API, which can be implemented in a UE of this disclosure (such as the UE 102). The method 400A can be implemented as a set of instructions stored on a computer-readable medium by processing hardware of the UE. As a more specific example, the method 400A can be implemented in the kernel or one of the drivers of the OS 210. The method begins at block 402A, where the UE detects that an application (e.g., the application 206 or the application 208 of FIG. 2) executing on an OS of the UE invoked an API for facilitating RAT selection (such as the RAT selection API 132).

At block 404A, the UE receives, via the API, a parameter related to data the application expects to communicate with a RAN (such as the RAN 105) within a certain period of time. At block 406A, the UE causes the RAN to select a RAT by transmitting the parameter to the RAN. The UE can transmit the parameter to the RAN in a message, such as a message conforming to the RRC protocol. The RAN can select a RAT based at least in part on the parameter using the techniques discussed above (e.g., by comparing the time that transfer of the data is expected to take over a first RAT to the time that transfer of at least a portion of the data is expected to take over the second RAT). Further, the RAN can also adjust other network resources based on the parameter to optimize network efficiency (e.g., by selecting a number of carriers, a carrier aggregation scheme, a number of MIMO layers, whether to release 5G carriers, etc.). In some implementations, at block 408A, the UE receives an indication of the selected RAT combination from the RAN. For example, the UE can receive an RRC message from the RAN indicating the selected RAT or RATs.

FIG. 4B is a flow diagram of an example method 400B for selecting a RAT in view of a parameter an application specifies via an API, which can be implemented in a UE of this disclosure (such as the UE 102). The method 400B is generally similar to the method 400A, except that the UE selects a RAT rather than causing the RAN to select a RAT by transmitting a parameter to the RAN. At blocks 402B-404B, the UE, as at blocks 402A-404A, detects that an application executing on an OS invoked an API for facilitating RAT selection and receives, via the API, a parameter related to data the application expects to communicate with the RAN within a certain period of time.

At block 406B, the UE selects a RAT or multiple RATs for communicating the data. As discussed previously, depending on the implementation and/or scenario, the UE can select a RAT and/or manage other network resources based on the application-provided parameters, using similar techniques to those discussed with reference to the RAN.

FIG. 4C is a flow diagram of an example method 400C for facilitating RAT selection, which can be implemented in a UE of this disclosure (such as the UE 102). At block 402C, the UE detects than an application executing on an OS invoked an API for facilitating RAT selection (e.g., blocks 402A and 402B of FIGS. 4A and 4B, respectively). Next, at block 404, the UE receives, via the API, a parameter related to data the application expects to communicate with a RAN within a certain period of time (e.g., blocks 404A and 404B of FIGS. 4A and 4B, respectively). At block 406C, the UE causes at least one RAT for communicating the data to be selected based at least in part on the parameter. The UE may cause a RAT or specific RATs to be selected by transmitting the parameter to the RAN (e.g., block 406A), or by selecting the RAT or RATs at the UE (e.g., block 406B).

In some implementations, the UE may cause a RAT or RATs to be selected using a combination of the techniques discussed with reference to blocks 406A and 406B. For example, the UE attached to a 4G RAT can determine, based on the parameter, that a 5G RAT should be selected for communicating the data. The UE may transmit an indication of this recommended RAT to the RAN, and the RAN may enable 5G carriers or cause the UE to continue using 4G carriers, depending on network conditions. As another example, the UE may perform a portion of the analysis related to selecting a RAT, such as comparing expected data rates at a location of the UE, and transmit the results of the analysis to the RAN. The RAN can use this information to select an appropriate RAT or RATs. Similarly, the RAN may perform a portion of the analysis relevant to selecting a RAT, and transmit the results to the UE, which can then select an appropriate RAT or RATs.

FIG. 5 is a flow diagram of an example method 500 for selecting a RAT based on a parameter specified by an application of a UE via an API call, which can be implemented in a RAN of this disclosure (such as the RAN 105). The method begins at block 502, where the RAN receives a parameter specified by an application executing on an OS of a UE (such as the UE 102) via an API call (e.g., via the RAT selection API 132). The parameter is related to data that the application expects to communicate with the RAN within a certain period of time.

At block 504, the RAN selects one or more RATs from multiple RATs for communicating the data based at least in part on the received parameter. In some implementations, at block 506, the RAN transmits an indication of the selected RAT or RATs to the UE. For example, the RAN can transmit a message, such as an RRC message, to the UE indicating the selected RAT(s). The RAN also may transmit an indication of the selected RAT(s) in a message related to a handover procedure, carrier aggregation configuration, or dual connectivity configuration.

The following list of examples reflects a variety of the embodiments explicitly contemplated by the present disclosure:

Example 1. A method for communicating data with a radio access network (RAN) in a user equipment (UE) that supports a plurality of radio access technologies (RATs), the method comprising: detecting, by processing hardware, that an application executing on an operating system (OS) invoked an application programming interface (API) for facilitating RAT selection; receiving, via the API, a parameter related to data the application expects to communicate within a certain period of time with the RAN; and causing at least one RAT to be selected from the plurality of RATs based at least in part on the parameter, for communicating the data.

Example 2. The method of example 1, wherein the causing includes: selecting the at least one RAT at the UE.

Example 3. The method of example 2, wherein the selecting includes: comparing, by the processing hardware when the UE is using a first RAT of the plurality of RATs, an amount of time that transfer of the data is expected to take over the first RAT to an amount of time that transfer of at least a portion of the data is expected to take over a at least one other RAT of the plurality of RATs.

Example 4. The method of example 3, wherein the amount of time that transfer of at least a portion of the data is expected to take over the at least one other RAT includes: (i) an amount of time that transfer of a first portion of the data is expected to take over the first RAT before a transition from the first RAT to the at least one other RAT completes, and (ii) an amount of time that transfer of a second portion of the data is expected to take over the at least one other RAT after the transition completes.

Example 5. The method of example 3 or 4, wherein the comparing includes: determining data rates for the first RAT and the at least one other RAT based on historical data indicative of communications using the first RAT and the at least one other RAT, respectively.

Example 6. The method of example 5, wherein the determining includes: determining the data rates in view of a current location of the UE.

Example 7. The method of example 2, wherein the selecting includes: comparing, by the processing hardware when the UE is using a first RAT of the plurality of RATs, an amount of power that transfer of the data over the first RAT is expected to require to an amount of power that transfer of at least a portion of the data over at least one other RAT of the plurality of RAT is expected to require.

Example 8. The method of example 7, wherein the amount of power that transfer of at least a portion of the data over the at least one other RAT is expected to require includes an amount of power that transition from the first RAT to the at least one other RAT is expected to require.

Example 9. The method of any of the preceding examples, further comprising: selecting, by the processing hardware and based at least in part on the parameter, a number of carriers of the selected at least one RAT the UE is to use to communicate the data.

Example 10. The method of any of the preceding examples, wherein the causing includes: selecting, by the processing hardware and based at least in part on the parameter, a carrier aggregation scheme or a multi-connectivity scheme the UE is to use to communicate the data.

Example 11. The method of any of the preceding examples, further comprising: selecting, by the processing hardware and based at least in part on the parameter, a number of multiple input, multiple output (MIMO) layers for the selected at least one RAT.

Example 12. The method of example 1, wherein the causing includes: transmitting the parameter to the RAN.

Example 13. The method of example 12, further comprising: receiving an indication of the selected at least one RAT from the RAN in response to the transmitting.

Example 14. The method of example 12, wherein the transmitting includes: transmitting a message associated with a protocol for controlling radio resources between the UE and the RAN, the message including the parameter.

Example 15. The method of any of any of the preceding examples, wherein the parameter indicates at least one of: (i) an amount of the data the application expects to communicate, (ii) a duration of a transfer session, (iii) a latency of the RAN in responding to the UE, or (iv) an interval between a first transfer session associated with the data and a second transfer session expected to occur subsequently to the first transfer session.

Example 16. The method of any of the preceding examples, wherein the API is an OS API available to a plurality of applications executing on the OS.

Example 17. The method of any of the preceding examples, wherein the plurality of RATs consists of: a first RAT with a first peak data rate, and a second RAT associated with a second peak data rate higher than the first peak data rate.

Example 18. The method of any of the preceding examples, wherein the causing includes: causing a first RAT and a second RAT to be selected; and wherein the method further comprises communicating the data in dual connectivity (DC) over the first RAT and the second RAT.

Example 19. The method of any of the preceding examples, further comprising: communicating with the RAN via a first RAT of the plurality of RATs prior to causing the at least one RAT to be selected.

Example 20. A method for communicating data with a radio access network (RAN) in a user equipment (UE) that supports carrier aggregation (CA), the method comprising: detecting, by processing hardware, that an application executing on an operating system (OS) invoked an application programming interface (API) for facilitating CA selection; receiving, via the API, a parameter related to data the application expects to communicate within a certain period of time with the RAN; and causing one of (i) carrier aggregation or (ii) single-carrier operation to be selected based at least in part on the parameter, for communicating the data.

Example 21. A user equipment comprising processing hardware and configured to implement a method according to any of the preceding examples.

Example 22. A non-transitory computer-readable medium storing thereon that implement an application programming interface (API) configured to perform a method of any of examples 1-20.

Example 23. A method in a radio access network (RAN) of radio access technology (RAT) selection for communicating with a user equipment (UE) that supports a plurality of RATs, the method comprising: receiving, by processing hardware and from a user equipment (UE), a parameter specified by an application executing on an operating system (OS) of the UE via an API call, the parameter related to data the application expects to communicate with the RAN within a certain period of time; and selecting, by the processing hardware and based at least in part on the received parameter, at least one RAT from the plurality of RATs for communicating the data.

Example 24. The method of example 23, further comprising: transmitting, by the processing hardware, an indication of the selected at least one RAT to the UE.

Example 25. The method of example 23 or 24, wherein the selecting includes: comparing, by the processing hardware when the UE is using a first RAT of the plurality of RATs, an amount of time that transfer of the data is expected to take over the first RAT to an amount of time that transfer of at least a portion of the data is expected to take over at least one other RAT of the plurality of RATs.

Example 26. The method of example 25, wherein the amount of time that transfer of at least a portion of the data is expected to take over the at least one other RAT includes: (i) an amount of time that transfer of a first portion of the data is expected to take over the first RAT before a transition from the first RAT to the at least one other RAT completes, and (ii) an amount of time that transfer of a second portion of the data is expected to take over the at least one other RAT after the transition completes.

Example 27. The method of example 25 or 26, wherein the comparing includes: determining data rates for the first RAT and the at least one other RAT based on historical data indicative of communications using the first RAT and the at least one other RAT, respectively.

Example 28. The method of example 27, wherein the determining includes: determining the data rates in view of a current location of the UE.

Example 29. The method of any of examples 23-28, further comprising: selecting, by the processing hardware and based at least in part on the parameter, a number of carriers of the selected at least one RAT the UE is to use to communicate the data.

Example 30. The method of any of examples 23-29, wherein the causing includes: selecting, by the processing hardware and based at least in part on the parameter, a carrier aggregation scheme or a multi-connectivity scheme the UE is to use to communicate the data.

Example 31. The method of any of examples 23-30, further comprising: selecting, by the processing hardware and based at least in part on the parameter, a number of multiple input, multiple output (MIMO) layers for the selected at least one RAT.

Example 32. The method of any of examples any of examples 23-31, wherein: the selected at least one RAT is different from an original RAT the UE is currently using to communicate with the RAN; the method further comprising: causing the UE to switch from the original RAT to the selected at least one RAT to communicate the data; and determining, by the processing hardware, whether the UE is to switch from the selected at least one RAT to the original RAT after completion of the communicating of the data.

Example 33. The method of any of examples 23-32, wherein the parameter indicates at least one of: (i) an amount of the data the application expects to communicate, (ii) a duration of a transfer session, (iii) a latency of the RAN in responding to the UE, or (iv) an interval between a first transfer session associated with the data and a second transfer session expected to occur subsequently to the first transfer session.

Example 34. The method of any of examples 23-33, wherein the selecting includes: selecting a first RAT and a second RAT to provide dual connectivity to the UE.

Example 35. A method in a radio access network (RAN) of carrier selection, the method comprising: receiving, by processing hardware and from a user equipment (UE), a parameter specified by an application executing on an operating system (OS) of the UE via an API call, the parameter related to data the application expects to communicate with the RAN within a certain period of time; and selecting, by the processing hardware and based at least in part on the received parameter, one of (i) carrier aggregation or (ii) single-carrier operation for the UE, for communicating the data.

Example 36. A radio access network including at least one base station and configured to implement a method of any of examples 23-35.

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method performed by a user equipment (UE) for communicating data with a radio access network (RAN), the UE being able to use different radio access technologies (RATs), the method comprising:
detecting that an application executing on the UE has invoked an application programming interface (API) to pass information for facilitating selecting one of the RATs, to lower one or more stacked layers of a protocol for the UE communicating with the RAN, the information including a parameter related to data the application expects to communicate within a certain period of time with the RAN, the lower one or more stacked layers receiving the parameter before receiving the data from the application or the RAN;
causing a RAT to be selected from the RATs based at least in part on the parameter communicating the data with the RAN using the selected RAT.

2. The method of claim 1, wherein the causing includes:
selecting the RAT at the UE.

3. The method of claim 2, wherein the selecting includes:
comparing, when the UE is using a first RAT of the RATs, a first amount of time that transfer of the data is expected to take over the first RAT to a second amount of time that the transfer of the data is expected to take if at least a portion of the data is transferred over at least one other RAT among the RATs, wherein the second amount of time includes: (i) an amount of time for transferring an initial portion of the data over the first RAT before a transition from the first RAT to the at least one other RAT completes, and (ii) an amount of time for transferring the at least a portion of the data over the at least one other RAT after the transition completes.

4. The method of claim 3, wherein the comparing includes:
determining data transfer rates for the first RAT and the at least one other RAT based on historical data indicative of communications using the first RAT and the at least one other RAT, respectively.

5. The method of claim 2, wherein the selecting includes:
comparing, when the UE is using a first RAT of the RATs, a first amount of power that transfer of the data over the first RAT is expected to require to a second amount of power that the transfer of the data is expected to require if at least a portion of the data is transferred over at least one other RAT of the RATs, wherein the second amount of power includes an amount of power that transitioning from the first RAT to the at least one other RAT is expected to require.

6. The method of claim 1, wherein the causing includes:
transmitting the parameter to the RAN.

7. The method of claim 1, wherein the parameter indicates at least one of:
(i) an amount of the data the application expects to communicate,
(ii) a duration of a transfer session,
(iii) a latency of the RAN in responding to the UE, or
(iv) an interval between a first transfer session associated with the data and a second transfer session expected to occur subsequently to the first transfer session.

8. The method of claim 1, wherein the API is an OS API available to a plurality of applications executing on an operating system (OS) of the UE.

9. (canceled)

10. A user equipment (UE) comprising processing hardware, the UE being able to use different radio access technologies (RATs) and configured to:
detect that an application executing on the UE invoked an application programming interface (API) to pass information to lower one or more stacked layers of a protocol for the UE communicating with a RAN, the information including a parameter related to data the application expects to communicate within a certain period of time with the RAN, the lower one or more stacked layers receiving the parameter before receiving the data from the application or the RAN;
cause a RAT to be selected from the RATs based at least in part on the parameter; and
communicating the data with the RAN using the selected RAT.

11. (canceled)

12. A method of radio access technology (RAT) selection performed by a radio access network (RAN) for communicating with a user equipment (UE), the UE being able to use different RATs, the method comprising:
receiving, by the RAN and from the UE, a parameter specified by an application executing on the UE via an API call, the parameter related to data the application expects to receive from the RAN within a certain period of time;
selecting, by the RAN and based at least in part on the received parameter, a RAT from the RATs; and
communicating the data using the selected RAT.

13. The method of claim 12, further comprising:
selecting, by the RAN and based at least in part on the parameter, at least one of:
a number of carriers of the selected at least ono RAT the UE is to use to communicate the data,
a carrier aggregation scheme or a multi-connectivity scheme the UE is to use to communicate the data; or
a number of multiple input, multiple output (MIMO) layers for the selected RAT.

14. The method of claim 12, wherein the parameter indicates at least one of:
(i) an amount of the data the application expects to communicate,
(ii) a duration of a transfer session,
(iii) a latency of the RAN in responding to the UE, or
(iv) an interval between a first transfer session associated with the data and a second transfer session expected to occur subsequently to the first transfer session.

15. (canceled)

16. The method of claim 12, wherein the selecting includes:
comparing, when the UE is using a first RAT of the RATs, a first amount of time that transfer of the data is expected to take over the first RAT to a second amount of time that the transfer of the data is expected to take if at least a portion of the data is transferred over at least one other RAT among the RATs.

17. The method of claim 16, wherein the second amount of time includes: (i) an amount of time for transferring an initial portion of the data over the first RAT before a transition from the first RAT to the at least one other RAT completes, and (ii) an amount of time for transferring the at least a portion of the data over the at least one other RAT after the transition completes.

18. The UE of claim 10, wherein to cause the RAT to be selected from the RATs, the UE is configured to:
select the RAT at the UE.

19. The UE of claim 18, wherein to select the RAT, the UE is configured to:
compare, when the UE is using a first RAT of the RATs, a first amount of time that transfer of the data is expected to take over the first RAT to a second amount of time that the transfer of the data is expected to take if at least a portion of the data is transferred over at least one other RAT among the RATs, wherein the second amount of time includes: (i) an amount of time for transferring an initial portion of the data over the first RAT before a transition from the first RAT to the at least one other RAT completes, and (ii) an amount of time for transferring the at least a portion of the data over the at least one other RAT after the transition completes.

20. The UE of claim 18, wherein to select the RAT, the UE is configured to:
compare, when the UE is using a first RAT of the RATs, a first amount of power that transfer of the data over the first RAT is expected to require to a second amount of power that the transfer of the data is expected to require if at least a portion of the data is transferred over at least one other RAT among the RATs, wherein the second amount of power includes an amount of power that transitioning from the first RAT to the at least one other RAT is expected to require.

21. The UE of claim 10, wherein to cause the RAT to be selected from the RATs, the UE is configured to:
transmit the parameter to the RAN.

22. The UE of claim 10, wherein the parameter indicates at least one of:
(i) an amount of the data the application expects to communicate,
(ii) a duration of a transfer session,
(iii) a latency of the RAN in responding to the UE, or
(iv) an interval between a first transfer session associated with the data and a second transfer session expected to occur subsequently to the first transfer session.

23. The UE of claim 10, wherein the API is an OS API available to a plurality of applications executing on an operating system (OS) of the UE.
